(19) United States
(12) Patent Application Publication
(10) Pub. No.: US 2026/0105012 A1
(43) Pub. Date: Apr. 16, 2026

(54) TSV TO COMMAND DECODER CONNECTION FOR HIGHER BANDWIDTHS

(71) Applicant: Micron Technology, Inc., Boise, ID (US)

(72) Inventors: Yasir Husain, Folsom, CA (US); Sujeet Ayyapureddi, Boise, ID (US)

(21) Appl. No.: 19/333,341

(22) Filed: Sep. 18, 2025

Related U.S. Application Data
(60) Provisional application No. 63/707,713, filed on Oct. 15, 2024.

(51) Int. Cl. G06F 13/16; G06F 13/40

(52) U.S. Cl. CPC G06F 13/1684; G06F 13/1621; G06F 13/4022

(57) ABSTRACT

A system-in-package (SiP) device includes a base substrate and a processing unit carried by the base substrate. The SiP also includes an HBM device carried by the base substrate and electrically coupled to the processing unit. The HBM device includes plurality of TSV buses associated with a same channel and an interface die having a bus switching circuit configured to select a TSV bus from the plurality of TSV buses and to communicatively couple a command signal bus to the selected TSV bus. The HBM device also includes one or more stacks carried by the interface die, with each stack having one or more dies. Each die includes a plurality of command decoder circuits associated with the same channel, and each command decoder circuit is adapted to decode command signals. Each command decoder circuit in each die is associated with a different TSV bus in the plurality of TSV buses.

### CROSS-REFERENCE TO RELATED APPLICATION(S)

The present application claims priority to U.S. Provisional Patent Application No. 63/707,713, filed Oct. 15, 2024, the disclosure of which is incorporated herein by reference in its entirety.

### TECHNICAL FIELD

The present technology is generally related to vertically stacked semiconductor devices and more specifically to vertically stacked high bandwidth storage devices for semiconductor packages.

### BACKGROUND

Microelectronic devices, such as memory devices, microprocessors, and other electronics, typically include one or more semiconductor dies mounted to a substrate and encased in a protective covering. The semiconductor dies include functional features, such as memory cells, processor circuits, imager devices, interconnecting circuitry, etc. To meet continual demands on decreasing size, wafers, individual semiconductor dies, and/or active components are typically manufactured in bulk, singulated, and then stacked on a support substrate (e.g., a printed circuit board (PCB) or other suitable substrates). The stacked dies can then be coupled to the support substrate (sometimes also referred to as a package substrate) through substrate (silicon) vias (TSVs) between the dies and the support substrate.

### BRIEF DESCRIPTION OF THE DRAWINGS

FIG. 1 is a partially schematic cross-sectional diagram of a related art system-in-package device.

FIG. 2A is a partial block diagram of a related art high bandwidth memory (HBM) device showing a command TSV bus for a channel.

FIG. 2B is a simplified related art timing diagram for command signal flow through the command TSV bus of a channel of a related art HBM device.

FIG. 3A is a partially schematic cross-sectional diagram of a system-in-package device that is consistent with the present disclosure.

FIG. 3B is a block diagram of an embodiment of a HBM device that is consistent with the present disclosure.

FIG. 4A is a schematic block diagram of a bus switching circuit that can be incorporated in an HBM device that is consistent with the present disclosure.

FIG. 4B is an embodiment of a switch than be used in a bus switching circuit that is consistent with the present disclosure.

FIG. 5 is a simplified timing diagram for command signal flows through a channel during that is consistent with the present disclosure.

FIG. 6 is a flow chart that shows a method of communicatively coupling a command signal bus to a TSV bus that is consistent with the present disclosure.

The drawings have not necessarily been drawn to scale. Further, it will be understood that several of the drawings have been drawn schematically and/or partially schematically. Similarly, some components and/or operations can be separated into different blocks or combined into a single block for the purpose of discussing some of the implementations of the present technology. Moreover, while the technology is amenable to various modifications and alternative forms, specific implementations have been shown by way of example in the drawings and are described in detail below. The intention, however, is not to limit the technology to the particular implementations described.

### DETAILED DESCRIPTION

High data reliability, high speed of memory access, higher data bandwidth, lower power consumption, and reduced chip size are features that are demanded from semiconductor memory. In recent years, vertically stacked memory devices have been introduced, often referred to as 2.5-dimensional (“2.5D”) memory devices when placed adjacent to a host device or 3-dimensional (“3D”) memory devices when stacked on top of the host device. Some 2.5D and 3D memory devices are formed by stacking memory dies vertically and interconnecting the dies using through-silicon (or through-substrate) vias (TSVs). The memory dies can be grouped in “stacks” with each stack, designated by a stack ID (“SID”), having one or more dies (e.g., 4 dies). Benefits of the 2.5D and 3D memory devices include shorter interconnects (which reduce circuit delays and power consumption), a large number of vertical vias between layers (which allow wide bandwidth buses between functional blocks, such as memory dies, in different layers), and a considerably smaller footprint. Thus, the 2.5 and 3D memory devices contribute to higher memory access speed, lower power consumption, and chip size reduction. Example 2.5D and/or 3D memory devices include Hybrid Memory Cube (HMC) and High Bandwidth Memory (HBM). For example, HBM is a type of memory that includes a vertical stack of dynamic random-access memory (DRAM) dies and an interface die (which, e.g., provides the interface between the DRAM dies of the HBM device and a host device). In the description below, the terms “stack” and “SID” are used interchangeably.

In a system-in-package (SiP) configuration, HBM devices may be integrated with a host device (e.g., a graphics processing unit (GPU), computer processing unit (CPU), a tensor processing unit (TCU), and/or any other suitable processing unit) using a base substrate (e.g., a silicon interposer, a substrate of organic material, a substrate of inorganic material and/or any other suitable material that provides interconnection between GPU/CPU and the HBM device and/or provides mechanical support for the components of a SiP device) through which the HBM devices and host communicate. Because traffic between the HBM devices and host device resides within the SiP (e.g., using signals routed through the silicon interposer), a higher bandwidth may be achieved between the HBM devices and host device than in conventional systems. In other words, the TSVs interconnecting DRAM dies within an HBM device, and the silicon interposer integrating HBM devices and a host device, enable the routing of a greater number of signals (e.g., wider data buses) than is typically found between packaged memory devices and a host device (e.g., through a printed circuit board (PCB)). The high bandwidth interface within a SiP enables large amounts of data to move quickly between the host device (e.g., GPU/CPU/TCU, etc.) and HBM devices during operation. For example, the high bandwidth channels can be on the order of 1000 gigabytes per second (GB/s, sometimes also referred to as gigabits (Gb)). As a result, the SiP device can quickly complete computing operations once data is loaded into the HBM devices. SiP devices, in turn, are typically integrated with a package substrate (e.g., a PCB) adjacent to other electronics and/or other SiP devices within a packaged system. It will be appreciated that such high bandwidth data transfer between the host device and the memory of HBM devices can be advantageous in various high-performance computing applications, such as video rendering, high-resolution graphics applications, artificial intelligence and/or machine learning (AI/ML) computing systems and other complex computational systems, and/or various other computing applications.

Market demands on SiP devices and/or the HBM devices therein can present certain challenges, however. One such challenge is that demands on SiP devices (and the HBM devices therein) require the devices to continually increase bandwidth and corresponding command signal rates. The increased command signal rates mean that the command signal paths in the HBM device operate at tight timing margins. In addition, higher bandwidths mean running the HBM device faster (e.g., a faster system clock frequency), which results in increased power consumption. For example, with respect to command signal rates, the command TSV bus circuits and command decoder circuits must operate at higher speeds, which means the HBM device runs at a higher power. Accordingly, it is desirable to increase the bandwidth on the HBM device while maintaining the same timings with respect to, for example, the command TSV buses and the command decoder circuits and while keeping power consumption as low as possible.

As used herein, the terms “vertical,” “lateral,” “upper,” “lower,” “top,” and “bottom” can refer to relative directions or positions of features in the devices in view of the orientation shown in the drawings. For example, “bottom” can refer to a feature positioned closer to the bottom of a page than another feature. These terms, however, should be construed broadly to include devices having other orientations, such as inverted or inclined orientations where top/bottom, over/under, above/below, up/down, and left/right can be interchanged depending on the orientation.

Further, although primarily discussed herein in the context of 2.5D HBM devices for SiP devices, one of skill in the art will understand that the scope of the present disclosure is not so limited. For example, various components of the SiP devices described herein can also be implemented in 3D HBM devices and various other stacked semiconductor devices to help with issues related to high data rates as discussed above. Accordingly, the scope of the present disclosure is not confined to any subset of embodiments and is confined only by the limitations set out in the appended claims.

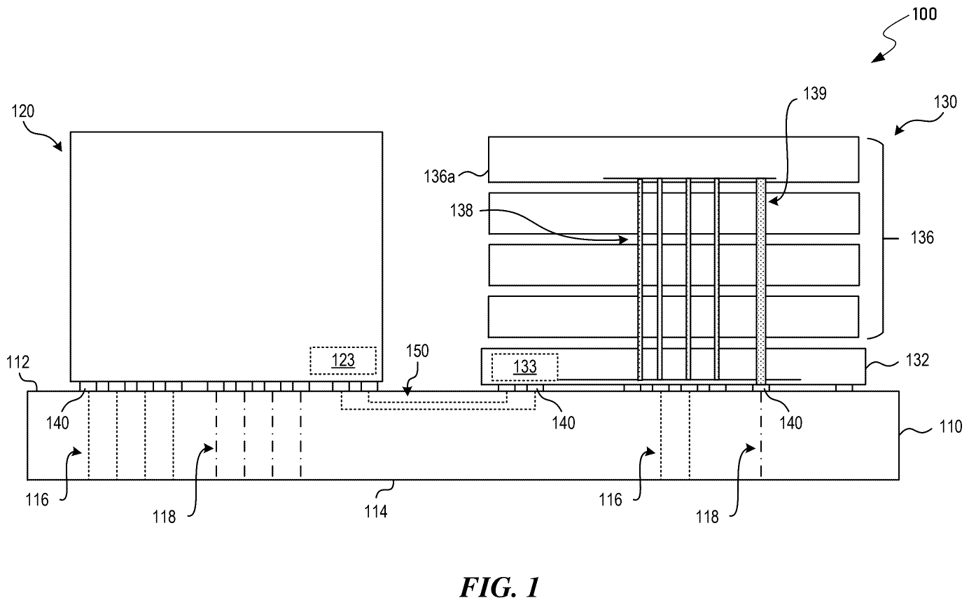

FIG. 1 is a partially schematic cross-sectional diagram of a related art SiP device 100. As illustrated in FIG. 1, the SiP device 100 includes a base substrate 110 (e.g., a silicon interposer, another organic interposer, an inorganic interposer, and/or any other suitable base substrate), as well as a host device 120 and an HBM device 130 each integrated with (e.g., carried by and coupled to) an upper surface 112 of the base substrate 110 through a plurality of interconnect structures 140 (three labeled in FIG. 1). The interconnect structures 140 can be solder structures (e.g., solder balls), metal-metal bonds, and/or any other suitable conductive structure that mechanically and electrically couples the base substrate 110 to each of the host device 120 and the HBM device 130. Further, the host device 120 is coupled to the HBM device 130 through one or more communication channels 150 formed in the base substrate 110. The communication channels 150 can include one or more route lines (two illustrated schematically in FIG. 1) formed into (or on) the base substrate 110.

As further illustrated in FIG. 1, the base substrate 110 includes a plurality of external signal TSVs 116 and a plurality of external power TSVs 118 extending between the upper surface 112 and a lower surface 114 of the base substrate 110. The external signal TSVs 116 can communicate signals (e.g., data, control signals, processing commands, and/or the like) between the host device 120 and/or the HBM device 130 and an external component (e.g., a PCB the base substrate 110 is integrated with, an external controller, and/or the like). The external power TSVs 118 provide electrical power to the host device 120 and/or the HBM device 130 from an external power source.

In the illustrated environment, the host device 120 can include a variety of components, such as a processing unit (e.g., CPU/GPU/TCU, etc.), one or more registers, one or more cache memories, and/or a variety of other components. For example, in the illustrated environment, the host device 120 includes a host IO circuit 123 that can direct signals to and/or from the HBM device 130 through the communication channels 150. Additionally, or alternatively, the host IO circuit 123 can direct signals to and/or from an external component (e.g., a controller coupled to one or more of the external signal TSVs 116 and/or the like).

The HBM device 130 can include an interface die 132 and a stack of one or more memory stacks 136 (four illustrated in FIG. 1) carried by the interface die 132. Each of the memory stacks 136 can include one or more DRAM dies (not shown in FIG. 1). Each memory stack 136 may encompass a physical and/or logical arrangement of one or more dies and can be associated with a stack ID (SID). The HBM device 130 also includes one or more signal TSVs 138 (four illustrated in FIG. 1) and one or more power TSVs 139 (one illustrated in FIG. 1) each extending from the interface die 132 to an uppermost memory stack 136a. The power TSV(s) 139 provide power (e.g., received from one or more of the external power TSVs 118) to the interface die 132 and each of the memory stacks 136. The signal TSVs 138, which include TSVs for carrying control, command (e.g., instructions from the host device 120 regarding one or more operations to be performed by the HBM device 130, such as read data commands, write data commands, and memory management commands), address, and data (DQ) signals, communicably couple a corresponding memory die in each of the memory stacks 136 to a HBM memory controller circuit 133 in the interface die 132 (in addition to various other circuits in the interface die 132). In turn, the HBM memory controller circuit 133 can direct DQ, control, command, and/or address signals to and/or from the host device 120 and/or an external component (e.g., an external storage device coupled to one or more of the external signal TSVs 116 and/or the like).

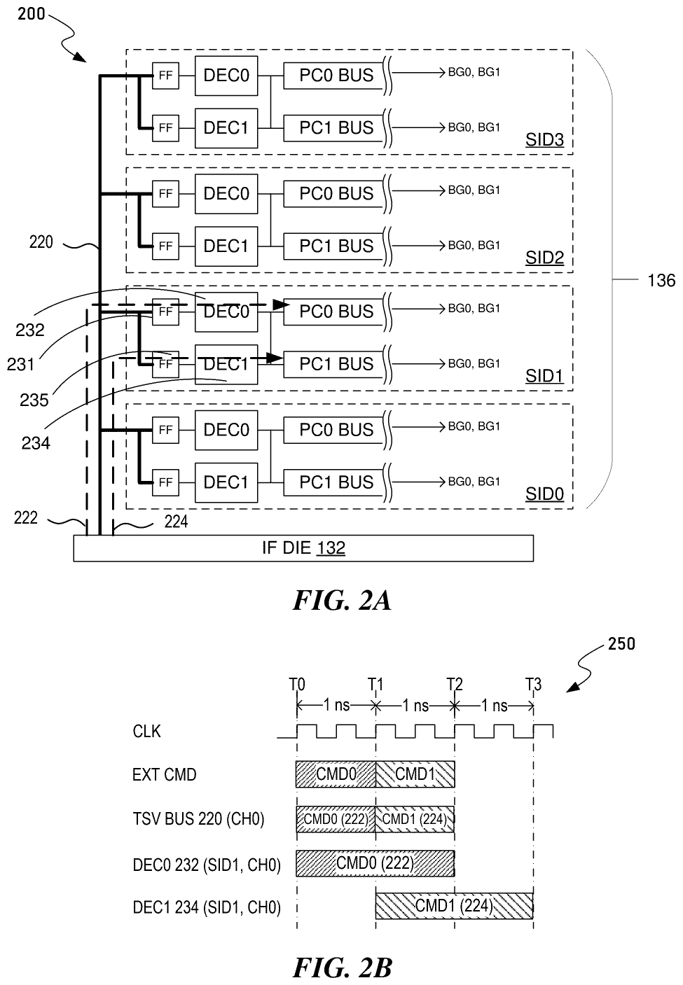

FIG. 2A illustrates a simplified block diagram of a related art HBM device 200, and FIG. 2B illustrates a simplified timing diagram 250 for command signal flow through the command TSVs of a channel of the related art HBM device 200 with respect to a command decode operation using a set of command TSVs (also referred to herein as a “command TSV bus” or a “TSV bus”). The block and timing diagrams can correspond to a related art HBM device with a data rate of 8 Gbps. For clarity and brevity, the DQ data timing is not shown. As used herein a “command TSV bus” or “TSV bus” can refer to one or more TSVs carrying signals (“command signals”) that command and/or instruct one or more components (e.g., DRAM dies) of an HBM device to perform one or more operations. For example, based on the context, a TSV bus can refer to all the command TSVs or a subset of the command TSVs in an HBM device (e.g., command TSVs corresponding to a channel).

FIG. 2A shows a simplified block diagram of a command decoding portion of a related art HBM device 200. For clarity, only a relevant portion of HBM device 200 is illustrated. The interface (IF) die 132 can include a memory controller circuit (e.g., the memory controller circuit 133 of FIG. 1) to receive external commands from a host device (e.g., the host device 120 of FIG. 1) and transmit the external commands on the TSV bus 220 (similar to signal TSVs 138 of FIG. 1). As explained further with respect to FIG. 2B, the HBM device 200 is controlled by one or more clock (CLK) signals that reflect the duration of predetermined timing parameters governing the operation of the HBM device 200, such as the command TSV bus access time (e.g., how much time a TSV bus has to distribute command signals the HBM device 200) and the command decoding time (e.g., of command decoding circuits DEC0 232 and DEC1 234). For example, in related art HBM devices (e.g., HBM device 200), the CLK frequency can be 2 GHz, which equals 0.5 ns per cycle (1/(2*10⁹)). The command TSV bus timing for the related art HBM devices (e.g., HBM device 200) can be 2 CLK cycles (1 ns) and the command decoding time can be 4 CLK cycles (2 ns). The command signal can include the type of operation to be performed on the memory arrays (e.g., activate, pre-charge, read, write, or another command operation). In addition, the command signal can have other information such as the SID number of the destination die, pseudo-channel (PC) channel number, and the bank address of the bank group (BG) to receive the command. As reflected in FIG. 2A, a first command (corresponding to command signal 222) and a second command (corresponding to command signal 224) may, for example, both have a destination die associated with SID1. The command signals 222 and 224 can be transmitted sequentially (e.g., over different clock cycles) by the host device (e.g., host device 120) and routed one after the other over TSV bus 220 (e.g., channel 0 bus) to SID1. The transmitted command signals 222 and 224 can be received by flip-flop circuits 231 and 235 from the TSV bus 220. The flip-flop circuits 231, 235 for each SID of each channel are alternately enabled so that sequential command signals to that SID and channel (e.g., commands signals 222 and 224 to SID1 on channel 0) are directed to different command decoder circuits (e.g., DEC0 232 or DEC1 234). Depending on the destination SID of the command signal (e.g., SID1), the flip-flop circuit of the appropriate channel and SID will be enabled so that the command signal is directed to the corresponding decoder. For example, in FIG. 2A, when the command signal 222 is transmitted through TSV bus 220, flip-flip circuit 231 can be initially enabled to direct command signal 222 to DEC0 232, and subsequently, when command signal 224 is transmitted through TSV bus 220, flip-flop circuit 235 can be enabled to direct command signal 224 to DEC1 234. Once decoded, the command decoder circuit transmits the command (e.g., activate, pre-charge, read, write, etc.) to the PC0 bus or the PC1 bus, as appropriate based on the information in the command signal. The command decoders DEC0 232 and DEC1 234 take 4 CLK cycles (2 ns) to decode the command signal. Because each channel of each SID includes two command decoders, while a command decoder DEC0 is decoding a command signal, the other command decoder DEC1 in the same SID can receive another command signal from IF die 132 for decoding.

The host device and the HBM device communicate using an interface protocol, which is provided to and/or configured in the host device prior to the start of memory operations. The timing parameters are part of the interface protocol between a host device and HBM device, and the HBM device may provide to the host device the timing requirements for scheduling memory operations. That is, the HBM device may let the host device know the CLK cycle settings for timing parameters. Thus, the predetermined timing parameters discussed above (e.g., TSV bus timing of 1 ns and command decoding timing of 2 ns) can be set according to the protocol standard for the HBM device 200. The host device observes any restrictions in the timing parameters when communicating with the HBM device. The host device will not violate the timing protocols when scheduling memory commands to the HBM device. That is, the host device will wait at least the number of cycles specified by a timing parameter before issuing successive commands that implicate a timing parameter (e.g., certain timing parameters specify a minimum number of cycles in between commands of certain types). Those skilled in the art understand the interface protocol between the host device and the HBM device and thus, for brevity, will not be further discussed except as needed to explain embodiments of the present disclosure.

As seen in the timing diagram 250 of FIG. 2B, the timing to transfer the command signal 222 through the TSV bus 220 to the command decoders is 2 CLK cycles (or 1 ns). The timing of command decoders, however, is 4 CLK cycles (2 ns). Accordingly, the flip-flop circuits 231,235 cooperate to alternate the incoming command signals (e.g., CMD0 222 and CMD1 224) between command decoder circuits DEC0 232 and DEC1 234 so that, when one of the decoders is busy decoding, the other decoder is ready to accept the transmitted command signal. For example, at time T0, the IF die 132 transmits a received external command signal 222 (also referred to as “CMD0”) from a host device 120 on the TSV bus 220. The command signal CMD0 is directed to SID1 on channel 0 (CH0). The flip-flop circuits circuit 231, 235 receive the command signal CMD0 and, flip-flop circuit 231 is enabled to send command signal CMD0 to DEC0 232, and DEC0 232 will start to decode command signal CMD0. At time T1, the circuit for TSV bus 220 has completed transmitting the command signal CMD0 to DEC0 232 and the flip-flop circuit 231 is disabled so that an incoming command signal is not transmitted to DEC0 232. In addition, flip-flop circuit 235 is enabled to transmit an incoming command signal to DEC1 234. However, DEC0 232 will still be decoding command signal CMD0 until time T2. Still at T1, the IF die 132 transmits command signal 224 (also referred to herein as “CMD1”) from host device 120 on TSV bus 220, which is then transmitted to DEC1 234 by flip-flip circuit 235. DEC1 234 then starts to decode command signal CMD1. At time T2, the circuit for TSV bus 220 has completed transmitting the command signal CMD1 to DEC1 234 and, the flip-flop circuit 235 is disabled so that an incoming command signal is not transmitted to DEC1 234. In addition, flip-flop circuit 231 is enabled to transmit an incoming command signal to DEC0 232. However, DEC1 234 will still be decoding command signal CMD1 until time T3. It will be appreciated the flop-flop circuits (described above and below) can be enabled and disabled using different mechanisms. For example, in some embodiments, the two flip-flop-circuits (e.g., flip-flop circuits circuit 231, 235) are clocked by two different clock signals that are offset from each other (e.g., by a phase and/or cycle) so that command signals on a TSV bus are alternately saved to one of the two flip-flop circuits based on the corresponding clock signal.

As seen in timing diagram 250, the timing of the external command signals matches the timing of the TSV bus circuits. For example, the externals commands from the host device (e.g., host device 120) have a timing of 2 CLK cycles (1 ns) and the TSV bus timing is also at 2 CLK cycles (1 ns). Thus, because the TSV bus circuit timing matches that of the external command signals, the circuit for the TSV bus (e.g., TSV bus 220) is able to process a first external command signal (e.g., CMD0) before receiving and processing the next external command signal (e.g., CMD1) on the same TSV bus (e.g., TSV bus 220).

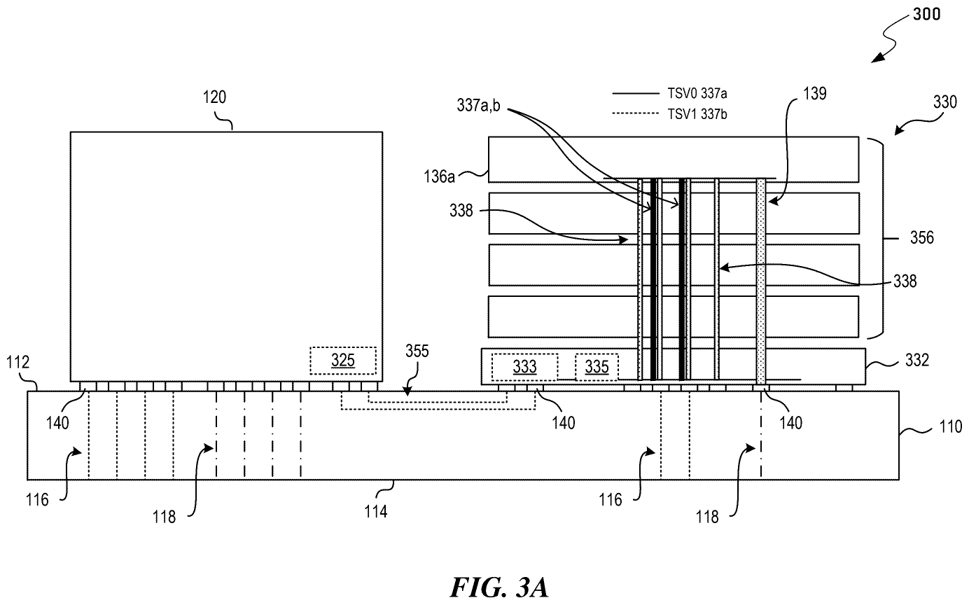

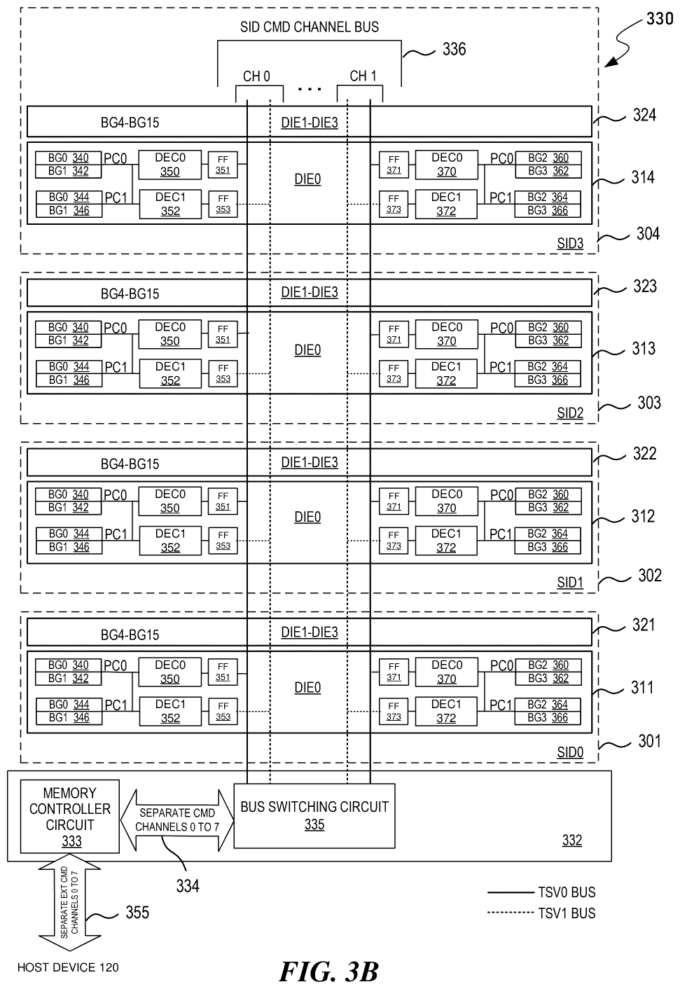

There is, however, a need to increase bandwidth of the communication between the host device and the HBM device on, e.g., communication bus 355 (see FIG. 3A) (e.g., from a data rate of 8 Gbps to greater than 8 Gbps such as, for example, 16 Gbps, 24 Gbps, 32 Gbps or more). Details on the HBM devices, SiP devices having HBM devices, and associated systems and methods consistent with the present disclosure, are set out below. For ease of reference, simplified assemblies of semiconductor packages (and their components) are described herein. It is to be understood, however, that the semiconductor assemblies (and their components) can be moved to, and used in, different spatial orientations without changing the structure and/or function of the disclosed embodiments of the present technology. Additionally, embodiments of the semiconductor packages (and their components) are sometimes described herein with reference to control, command, read, and/or write signals. It is to be understood, however, that the signals can be described using other terminology and/or the embodiments can use other types of signals that are not discussed without changing the structure and/or function of the disclosed embodiments of the present technology.

To achieve increased bandwidth, the CLK cycle frequency and, along with the data rate, the command signal rate can be increased accordingly. For example, the CLK frequency used to control the interface between an HBM device and host device may be increased (e.g., external commands received from a host may be associated with a CLK signal having a shorter cycle time). As described above, in related art HBM devices, the command TSV bus that distributed command signals through the HBM device may operate at the same timing as external commands. However, a potential issue with increasing the command TSV bus frequency (i.e., to match the frequency of the clock signal used for external commands) is that, because the command signal paths in the HBM device operate at tight timing margins, an increase in the command signal rate at the TSV bus can result in a slip in the timing margins. That is, an increased command signal rate can mean that the TSV bus timing, the command decoder timing, and/or the memory timing (e.g., memory array timing of the die) will need to run at higher speeds (which requires more power) and/or the timing margins can no longer be met. Accordingly, increasing the TSV bus timing frequency and/or the command decoder circuits to match that of the external bus is not desirable because the power consumption in the HBM device will also increase.

Therefore, it is desirable to increase the bandwidth of HBM devices (e.g., the rate at which commands can be received from a host device, such as by increasing the frequency of a clock signal associated with receiving external commands) while maintaining the same timing (e.g., the elapsed real time or “wall-clock time”) of the TSV bus circuits and/or the command decoder circuits found in related art HBM devices (e.g., HBM devices following the JEDEC Standard, High Bandwidth Memory DRAM (HBM4) Specification). In addition, it is also desirable to keep power consumption on the HBM device as low as possible.

Embodiments of the present disclosure enable an increased bandwidth in comparison to related art HBM devices while still keeping the timings on the command TSV bus circuits and the command decoder circuits the same. To increase the bandwidth, the command and data rates of the external signals from, for example, a host device can be increased (e.g., doubled, tripled, etc.). To accommodate the increased command rate, each DRAM channel can include multiple command TSV buses corresponding to the amount of increase and each die can have multiple command decoder circuits associated with the same DRAM channel. As described herein, by increasing the number of command TSV buses per-channel in an HBM device in accordance with embodiments of the disclosed technology, each TSV bus can utilize a greater number of CLK cycles to transmit command signals over the TSV bus, such that the wall-clock time utilized by the TSV bus remains unchanged compared to a related art HBM device (e.g., the CLK cycle frequency doubles, but the number of CLK cycles the TSV bus uses to transmit command signals for a given command also doubles). As further described herein, the multiple per-channel TSV buses, in aggregate, are synchronized to the data rate of the external commands, despite the fact that each individual TSV bus may utilize a greater number of CLK cycles to transmit command signals). In addition, each of the command decoders associated with the same DRAM channel can be communicatively coupled to a different command TSV bus for the DRAM channel. For example, if the command rate is doubled in comparison to a related art HBM device, the number of command TSV buses may be doubled from one to two TSV buses for each DRAM channel. In addition, the two command decoder circuits associated with the DRAM channel in the die will communicatively couple to a different TSV bus. The multiple TSV buses for each channel keep the overall data rate through the command TSV buses the same as that of the external command signals to the IF die (e.g., IF die 332) without incurring certain shortcomings (e.g., raising the voltage of the TSV bus to accommodate a faster clock signal). That is, embodiments of the present disclosure increase the number of available TSV command signal paths per channel so that a greater amount of data can be transmitted over the TSVs at any given time. By using multiple TSV command signal paths, consecutive command signals (e.g., activate, pre-charge, read, write, etc.) can use separate TSV command signal paths in a “pipeline” type arrangement with the respective command decoder circuits for the channel. Accordingly, the command signal rate over a given TSV command path can be lower than that of the command signal bus in IF die (e.g., IF die 332) while the command signal rate across all TSV command paths matches that of the command signal bus. Accordingly, the command TSV bus circuit timing and the command decoder circuit timing need not be changed to accommodate the higher bandwidth of embodiments of the present disclosure. In addition, in embodiments of the present disclosure, the command signal rate (and corresponding voltage) through an individual command TSV or command TSV bus can be kept low enough to permit low swing signaling while still keeping the overall data rate on the command TSVs equal to that of the command signal bus in the IF die. Additional details of embodiments of the present disclosure are discussed below.

FIG. 3A is a partially schematic cross-sectional diagram of an embodiment of a SiP device 300 that is consistent with the present disclosure. SiP device 300 is similar to SiP device 100 and components that are the same are identified with the same reference numbers. Accordingly, the functions of those components will not be discussed further. Host IO circuit 325, HBM memory controller circuit 333, interface die 332, and communication bus 355 have the same functions as Host IO circuit 123, HBM memory controller circuit 133, interface die 132, and communication channel 150, respectively, as discussed above with respect to FIG. 1. However, in some embodiments, these components can be configured to and/or may include different circuits to handle an increased data rate (e.g., 16 Gbps, 24 Gbps, 32 Gbps, etc.). In addition, DQ and address TSVs 338 can correspond to the signal TSVs 138 discussed above, but may only transmit DQ and/or address signals. Command signals may be transmitted by command TSV buses 337a,b (a single TSV in each of the TSV buses is illustrated in FIG. 3A). A pair of TSV buses (e.g., TSV bus 337a and TSV bus 337b) can correspond to a channel and transmit signals from/to the respective SIDs and the corresponding channel (e.g., channel 0-7) in the command channel bus in interface die 332. TSV bus 337a can correspond to the TSV0 bus of the channel and TSV bus 337b can correspond to the TSV1 bus of the channel. The interface die 332 can include a bus switching circuit 335 that selectively and communicatively couples the corresponding channel (e.g., channel 0-7) of a command channel bus in the IF die 332 to either of the TSV buses 337a,b (TSV0 and TSV1), as discussed below. In addition, stacks 356 can have a different configuration than stacks 136 in FIG. 1, as discussed below.

FIG. 3B illustrates a block diagram of the HBM device 330 of FIG. 3A. The illustrated embodiment in FIG. 3B has a 4N architecture in that the HBM device 330 includes four stacks SID0-SID3, which can be the same as stacks 356 in FIG. 3A, and each of the stacks SID0-SID3 (labeled 301, 302, 303, and 304, respectively) can include four DRAM dies DIE0-DIE3 (die DIE0 in each stack is labeled 311, 312, 313, and 314, respectively, and dies DIE1-DIE3, in each stack are collectively labeled 321, 322, 323, and 324, respectively). However, other embodiments can have other arrangements in which the number of stacks and/or dies can be fewer or greater. For example, in some embodiments, the number of stacks and/or dies can be 1, 2, or 3.

Each die can have one or more channels that provide independent data access to one or more banks of memory arrays (not shown). Applicant's co-pending U.S. patent application Ser. Nos. 19/201,529, 19/201,569, 19/201,673, and 19/201,689 (respectively corresponding to U.S. Provisional Application Nos. 63/647,437, 63/647,483, 63/647,466, and 63/647,493, filed on May 14, 2024), which are incorporated herein by reference in their entirety, disclose configurations for data buses and circuits that are compatible with the present disclosure, and thus, for brevity, configuration of the data buses and circuits are not discussed further. In the embodiment of FIG. 3B, channels 0 and 1 of the SID command channel bus 336 are shown extending through the stacks (or SIDs) 301-304. Dies 311-314 in respective stacks 301-304 have bank groups BG0 340 and BG1 342 corresponding to pseudo-channel PC0 and bank groups BG0 344 and BG1 346 corresponding to pseudo-channel PC1, which can communicatively couple to channel 0. For channel 1, dies 311-314 in respective stacks 301-304 have bank groups BG2 360 and BG3 362 corresponding to pseudo-channel PC0 and bank groups BG0 344 and BG1 346 corresponding to pseudo-channel PC1. Each bank group can include one or more memory banks (e.g., 8 memory banks) that each include one or more memory arrays. The other channels 2-7 (not shown) have similar configurations but communicatively couple to different bank groups in different dies. For example, the other channels may couple to bank groups BG4 through BG15.

In some embodiments, each channel 0-7 of the SID command channel bus 336 can be split into two pseudo-channels that operate semi-independently such as, for example, pseudo-channel PC0 corresponding to DQ bits 0-31 and pseudo-channel PC1 corresponding to DQ bits 32-64. However, in other embodiments, the channels are not split into pseudo-channels. The channels and/or pseudo-channels can provide independent access to corresponding BGs, where each BG can include one or more banks. For example, if a die has 16 banks, each BG can have four banks and an independent channel can provide access to that BG. A die can include fewer banks than 16 such as, for example, 4 banks, 8 banks, etc. In some embodiments, a die can include more than 16 banks. Similarly, the number of BGs in a die can be fewer or greater than four. Segmenting a memory device into banks and bank groups is known in the art and thus, for brevity, will not be further discussed. In addition, those skilled in the art understand that an HBM device can have different arrangements with respect to the number of dies, banks, bank groups, channels, and/or pseudo-channels than in the disclosed embodiments and still be consistent with the present disclosure.

In some embodiments, each channel of each SID can have two command decoder circuits DEC0 and DEC1. For example, as seen in FIG. 3B, channel 0 of SID0 301 includes command decoder circuits DEC0 350 and DEC1 352. The output of each command decoder circuit DEC0 350 and DEC1 352 connects to both the PC0 bus and the PC1 bus. That is, the command decoder circuits can select and transmit the decoded command to either of the pseudo-channels (e.g., depending on which one is addressed by the command). In some embodiments, the command decoder circuits can include and/or be connected to flip-flop circuits (e.g., flip-flop circuits 351, 353, 371, and 373 in FIG. 3B), which can be similar to flip-flop circuits 231,232 to ensure that, when enabled, the command signals from the IF die 332 are received by the command decoder circuit corresponding to the SID addressed in the command. Based on the decoded information, the command from, for example, host device 120 can be sent to any one of the bank groups 340, 342, 344, or 346. Similarly, channel 1 of SID 301 includes command decoder circuits DEC0 370 and DEC1 372, and the output of each command decoder circuit DEC0 370 and DEC1 372 connects to the PC0 bus and the PC1 bus. Based on the decoded information, the command from, for example, host device 120 can be sent to any one of the bank groups 360, 362, 364, or 366. The command decoder circuits (DEC0 and DEC1) in the other dies DIE0s of SIDs 302-304 and the command decoder circuits (not shown) in dies DIE1-DIE3 of SIDs 301-304 can be similarly configured.

The following description refers to, as an illustrative example, channel 0 in dies 311, 312, 313, and 314 in respective SIDs 301, 302, 303, and 304. However, the description is applicable to channel 1 and the other die groups 321, 322, 323, and 324 (each group representing dies die1-die3), and thus for brevity and clarity is not repeated. As seen in FIG. 3B, each channel 0 to 7 of SID command channel bus 336 can include two command TSV buses (TSV0 and TSV1). For clarity, only the TSV0 and TSV1 buses for channels 0 and 1 are shown, but those skilled in the art understand that the other channels 2-7 can also include a TSV0 bus and a TSV1 bus for each respective bus as well. As discussed further below, the command decoder circuits DEC0 350 and DEC1 352 for each die of channel 0 can be respectively communicatively coupled to the TSV0 bus and the TSV1 bus.

In related art systems each channel includes one command TSV bus per channel to communicate with both command decoders associated with the channel. However, in exemplary embodiments of the present disclosure, the command decoder circuits for each channel of each die communicate with a separate TSV bus of the channel. For example, the DEC0 350 of channel 0 of SID1 302 can be communicatively coupled to the TSV0 bus (solid line) and DEC1 352 of channel 0 of SID1 302 can be communicatively coupled to the TSV1 bus (dotted line). Likewise, DEC0 370 of channel 1 of SID1 302 can be communicatively coupled to the TSV0 bus (solid line) and DEC1 372 of channel 1 of SID1 302 can be communicatively coupled to the TSV1 bus (dotted line). The command decoder circuits in the other stacks and for the other channels can be similarly communicatively coupled to the TSV0 bus or the TSV1 bus of the respective channel, as appropriate. Although, two command decoder circuits per channel per SID are discussed above, in other embodiments, if the channel includes three or more TSV buses, there can be three or more command decoder circuits per channel per SID with each command decoder circuit corresponding to a separate TSV bus of the channel. As discussed further below, the split arrangement of command decoder circuits with the corresponding TSV buses can provide different command signal paths to help relax the timing constraints on the command TSV bus.

As seen in FIG. 3B, a bus switching circuit 335 is located in interface die 332 along with the HBM memory controller circuit 333. However, some or all of the functions of bus switching circuit 335 can be incorporated into the HBM memory controller circuit 333 and/or another circuit. The bus switching circuit 335 communicatively couples to the HBM memory controller circuit 333 to receive/transmit the command signals for each channel on interface (IF) command channel bus 334 from/to the HBM memory controller circuit 333. In some embodiments, the external command signals from, for example, host device 120 can be transmitted to memory controller circuit 333 on, for example, separate external command channels 0 to 7, which can be part of communication bus 355. Thus, the HBM memory controller circuit 333 can control external access to the IF command channel bus 334 and bus switching circuit 335 and can manage the command signals to and from the bus switching circuit 335 based on, for example, the memory operation (e.g., activate, pre-charge, read, write, etc.). Configuration and operation of HBM memory controller circuits are known to those skilled in the art and thus, for brevity, will not be discussed further.

As discussed above, the HBM memory controller circuit 333 can receive the external command signals (e.g., on separate command channels 0-7) from the host device and transmit the command signals to the bus switching circuit 335 on corresponding separate command channels 0-7 of the IF command channel bus 334. The command signals can then be transmitted by the bus switching circuit 335 to the SIDs (e.g., SID0-3) on the corresponding channel 0 to 7 of the SID command channel bus 336. However, each channel 0 to 7 of the IF command channel bus 334 can include a single command signal bus while each channel 0 to 7 of the SID command channel bus 336 can include multiple command signal buses (e.g., TSV buses) such as, for example, a TSV0 bus and a TSV1 bus. Accordingly, in some embodiments, for each channel on the SID command channel bus 336, the bus switching circuit 335 selects one of the TSV buses (e.g., TSV0 bus or TSV1 bus) and communicatively couples the corresponding channel of the IF command channel bus 334 to the selected TSV bus. For example, the bus switching circuit 335 can select and communicatively couple a channel (e.g., channel 0) of the IF command channel bus 334 to a selected TSV bus (e.g., TSV0 bus or TSV1 bus) of the corresponding channel (e.g., channel 0) of the SID command channel bus 336. The selection can be based on, for example, a TSV select signal. The TSV select signal, discussed further below, can be configured such that the bus switching circuit 335 selects between TSV buses in an alternating pattern, in a round-robin pattern, and/or another type of pattern.

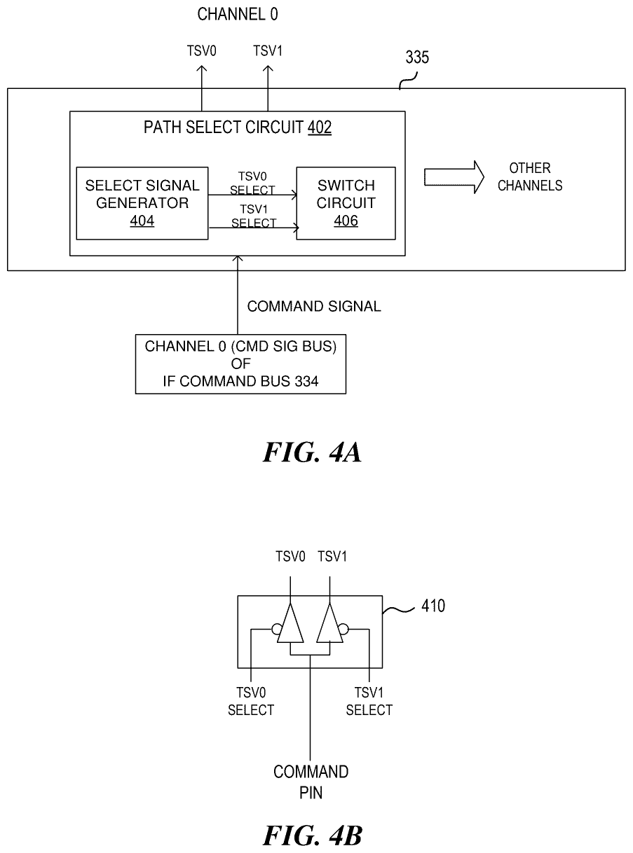

FIG. 4A is a block diagram showing a portion of the bus switching circuit 335 that can select and communicatively couple a TSV bus of a channel to the command signal bus in the IF die 332 corresponding to the channel. For example, in some embodiments, a path select circuit 402 can select between multiple TSV buses (e.g., between two TSV buses, TSV0 and TSV1) for channel 0 and communicatively couple the command signal bus in the IF die 332 for channel 0 to the selected TSV bus. For brevity and clarity, FIG. 4A only shows the path selection circuit for channel 0. However, those skilled in the understand that selection of the appropriate TSV bus for other channels can have similar circuits. That is, each channel may have a corresponding path select circuit 402.

In some embodiments, a command signal from the host device (e.g., host device 120) and/or HBM memory controller circuit 333 (and/or another circuit) is transmitted to the path select circuit 402 of bus switching circuit 335 over channel 0 of the IF command channel bus 334. The path select circuit 402 (and/or another circuit) can include one or more processors, memory, look-up-table, combinatorial logic, state (e.g., flip-flops, latches, etc.), and/or other circuits to determine and select the appropriate TSV bus (e.g., TSV0 or TSV1). For example, in some embodiments, the path select circuit 402 can include select signal generator 404 and a switch circuit 406. The select signal generator 404 can include circuits to generate a path select signal or signals (e.g., TSV0 select and TSV1 select) for selecting between TSVs (or TSV buses) based on a predetermined selection pattern. In some embodiments, the predetermined selection pattern can be an alternating pattern that selects between the multiple TSV buses (e.g., between TSV0 and TSV1) of a channel in a predetermined sequence (e.g., TSV0, TSV1, TSV0 and so on) such that the same TSV bus for the channel is not selected on consecutive command signals for that channel. For example, when the path select circuit 402 receives a command signal from the command signal bus, the path select circuit 402 can select a TSV bus that was not used by the immediately prior command signal for the channel. In other embodiments, the predetermined selection pattern can include selecting a default TSV bus (e.g., TSV0 bus) for every command signal so long as the default TSV and/or the command decoder circuit receiving the command signal on the default TSV bus is not already busy decoding a previous command signal. If the default command decoder is busy, then another TSV bus and the corresponding command decoder for the channel and SID can be selected.

In some embodiments, the switch circuit 406 can include multiple bit-switches corresponding to individual command bit pins of the command signal bus in IF die 332. FIG. 4B shows an embodiment of an individual bit-switch 410 that can be included in the switch circuit 406. As seen in FIG. 4B, the bit-switch 410 can include one or more tri-state inverter circuits (or another appropriate switch circuit) to communicatively couple the command signal bus pin to the appropriate TSV or TSVs. The bit-switch 410 can receive a path select signal or signals from the select signal generator 404 and, based on the path select signal(s), communicatively couple the command pin to the selected TSV (e.g., TSV0 or TSV1). For example, if the TSV0 select signal is enabled, a command bit path between the command pin and a TSV on the TSV0 bus is selected. If the TSV1 select signal is enabled, a command path between the command pin and a TSV on the TSV1 bus is selected. In some embodiments, if no path select signal is enabled, then no command bit path is selected (e.g., because a command signal is not being transmitted to the command decoder circuit). In some embodiments, three or more select signals can be respectively generated if the channel includes three or more TSV buses. In some embodiments, when the channel has two TSV buses, one TSV select signal can be used and bit-switch 410 selects one of the TSVs when the path select signal is enabled and the other TSV when the path select signal is not enabled. In operation, for the embodiment of FIGS. 3A and 3B, when the HBM memory controller circuit 333 receives a command signal from, for example, host device 120 and transmits the command signal to the bus switching circuit 335 over IF command channel bus 334, the path select circuit 402 for the channel corresponding to the command signal in the bus switching circuit 335 selects either the TSV0 bus or the TSV1 bus based on the predetermined selection pattern discussed above. As a further embodiment, the switch circuit 406 can include multiple 1-to-many demultiplexers, which drive a command signal on to one of the TSVs based on a select signal (e.g., generated by the select signal generator 404).

As discussed above, to increase bandwidth, the host device (e.g., host device 120) can send command signals at a higher rate (e.g., a command rate corresponding to a data rate of greater than 8 Gbps such as, for example, 16 Gbps, 24 Gbps, 32 Gbps or more). The HBM memory controller circuit 333 and/or the bus switching circuit 335 can transmit the received command signals to the corresponding command decoder circuits in the SIDs via a command TSV bus. However, in some embodiments, to ensure that the timings of the command TSV bus and that of the command decoder circuits remain the same as those in the related art HBM devices, additional command TSV buses are added for each channel and a path select circuit routes the command signals between multiple TSV buses of a same channel, as discussed above. For example, if there are two TSV buses per channel, as discussed above, the path select circuit 402 can route the commands such that the TSV0 and TSV1 buses (and thus the respective command decoder circuits) are selected in an alternating pattern. Accordingly, although the increased bandwidth of an HBM device means the timing of the external command signals (e.g., from the host device) are faster (e.g., a new command signal every 0.5 ns for a bandwidth that is doubled), by alternating the TSV buses, the TSV bus circuit timing can be kept the same as the related art HBM device (e.g., TSV bus timings at 1 ns and command decoder circuit timings at 2 ns.

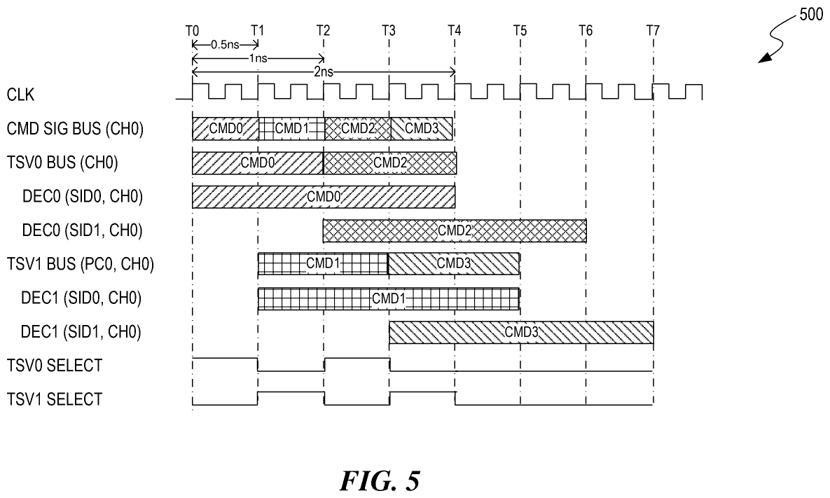

FIG. 5 illustrates a simplified timing diagram 500 for command operations that are consistent with embodiments of the present disclosure. The timing diagram illustrates, in simplified form, the operations of an HBM device that has a data rate of 16 Gbps and two TSV buses per channel. Although the command signals from the external command signal bus are still separated by two CLK cycles as in the system of FIG. 2, due to the increased bandwidth and CLK frequency (e.g., doubling the CLK frequency), the HBM device now receives different command signals from the host that are separated by 0.5 ns (instead of 1 ns). As seen in FIG. 5, the external command signals are transmitted through the command TSV buses of the HBM device in an alternating pattern. For example, command signals CMD0 and CMD1 are transmitted through TSV0 and command signals CMD1 and CMD3 are transmitted through TSV1. Accordingly, although the HBM device receives external command signals (e.g., a new command, from the host, over a channel) every 2 CLK cycles (0.5 ns), each command signal can access the corresponding TSV bus for four CLK cycles (1 ns), thereby maintaining the elapsed real time (compared to related art HBM devices) the TSV bus has to transmit the command signals throughout the HBM device. Furthermore, the command decoder timing of 2 ns (compared to related art HBM devices) need not be changed.

The command signal flow path is discussed further below with respect to FIG. 5. For clarity, in FIG. 5, the different command signal flows are identified using different hashlines and crosshatches. In addition, command signals CMD0 and CMD1 are directed to bank groups in SID0, and command signals CMD2 and CMD3 are directed to bank groups in SID1. Also, command signals CMD0 and CMD2 are transmitted via the TSV0 bus, and command signals CMD1 and CMD3 are transmitted via the TSV1 bus.

The time from T0 to T4 corresponds to 2 ns, which is 8 CLK cycles in this embodiment. As seen in FIG. 5, four command signals (CMD0, CMD1, CMD2, and CMD3) can be received by the HBM device on channel 0 during the 8 CLK cycle period, which allows for more bandwidth than related art devices that only receive two command signals over the same elapsed real time. That is, in related art devices (with a slower CLK frequency) 2 ns of elapsed real time corresponds to 4 CLK cycles, which would permit only two command signals (CMD0 and CMD1). As described herein, the present technology enables increasing the CLK frequency, so that more command signals can be transmitted by a host to an HBM device over a given elapsed real time, without changing the amount of real time during which command signals can be transmitted over TSV buses within the HBM device.

At time T0, the command signal CMD0 is available on the command signal bus (e.g., channel 0 on command channel bus 334) for 2 CLK cycles (0.5 ns) until time T1. In addition, based on, for example, a selection pattern, the TSV0 select signal of path select circuit 402 goes high (and the TSV1 select signal goes low) to select the TSV0 bus corresponding to, for example, channel 0 in SID0. The TSV bus circuit has access to the command signal bus for 2 CLK cycles (0.5 ns) and transmits the command signal CMD0 to command decoder circuit DEC0 in SID0 via the TSV0 bus of channel 0. As seen in FIG. 5, once the transmission starts, the command decoder circuit DEC0 of SID0 has access to the corresponding TSV0 bus for 4 CLK cycles (1 ns) before the TSV0 bus is released. However, the command decoder circuit DEC0 of SID0 can still use 8 CLK cycles (2 ns) to decode the command signal CMD0. Accordingly, the timings of the TSV bus circuits and command decoder circuits can remain the same as that of a related art HBM device that has a data rate of 8 Gbs.

At time T1, the TSV bus circuit for TSV0 and the command decoder circuit for DEC0 of SID0 are still processing the command signal CMD0, but the command signal bus has been released from processing command signal CMD0. The command signal CMD1 is now available on the command signal bus for 2 CLK cycles (0.5 ns) until time T2. In addition, based on, for example, a selection pattern, the TSV1 select signal of path select circuit 402 goes high (and the TSV0 select signal goes low) to select the TSV1 bus corresponding to, for example, channel 0 in SID0. The TSV bus circuit has access to the command signal bus for 2 CLK cycles (0.5 ns) and transmits the command signal CMD1 to command decoder circuit DEC1 in SID0 via the TSV1 bus for channel 0. As seen in FIG. 5, once the transmission starts, the command decoder circuit DEC1 of SID0 has access to the corresponding TSV1 bus for 4 CLK cycles (1 ns) before the TSV1 bus is released. However, the command decoder circuit DEC1 of SID0 can still use 8 CLK cycles (2 ns) to decode the command signal CMD1.

At time T2, the command decoder circuit for DEC0 of SID0 is still processing the command signal CMD0, and the TSV bus circuit for TSV1 and the command decoder circuit for DEC1 of SID0 are still processing the command signal CMD1. However, the command signal bus has been released from processing command signal CMD1, and the TSV0 bus has been released from processing command signal CMD0. The command signal CMD2 is now available on the command signal bus for 2 CLK cycles (0.5 ns) until time T3. In addition, based on, for example, a selection pattern, the TSV0 select signal of path select circuit 402 goes high (and the TSV1 select signal goes low) to select the TSV0 bus corresponding to, for example, channel 0 in SID1. The TSV bus circuit has access to the command signal bus for 2 CLK cycles (0.5 ns) and transmits the command signal CMD2 to command decoder circuit DEC0 in SID1 via the channel 0 TSV0 bus. As seen in FIG. 5, once the transmission starts, the command decoder circuit DEC0 of SID1 has access to the corresponding TSV0 bus for 4 CLK cycles (1 ns) before the TSV0 bus is released. However, the command decoder circuit DEC0 of SID1 can still use 8 CLK cycles (2 ns) to decode the command signal CMD2.

At time T3, the command decoder circuit for DEC0 of SID0 is still processing the command signal CMD0, and the command decoder circuit for DEC1 of SID0 is still processing the command signal CMD1. In addition, the TSV0 bus is still processing command signal CMD2. However, the command signal bus has been released from processing command signal CMD2, and the TSV1 bus has been released from processing command signal CMD1. The command signal CMD3 is now available on the command signal bus for 2 CLK cycles (0.5 ns) until time T4. In addition, based on, for example, a selection pattern, the TSV1 select signal of path select circuit 402 goes high (and the TSV0 select signal goes low) to select the TSV1 bus corresponding to, for example, channel 0 in SID1. The TSV bus circuit has access to the command signal bus for 2 CLK cycles (0.5 ns) and transmits the command signal CMD3 to command decoder circuit DEC1 of SID1 via the channel 0 TSV1 bus. As seen in FIG. 5, once the transmission starts, the command decoder circuit DEC1 of SID1 has access to the corresponding TSV1 bus for 4 CLK cycles (1 ns) before the TSV1 bus is released. However, the command decoder circuit DEC1 of SID1 can still use 8 CLK cycles (2 ns) to decode the command signal CMD2.

At time T4, the command decoder circuit for DEC0 of SID0 has completed processing the command signal CMD0. The command decoder circuit for DEC1 of SID0 is still processing the command signal CMD1, the command decoder circuit for DEC0 of SID1 is still processing the command signal CMD2, and the command decoder circuit for DEC1 of SID1 is still processing the command signal CMD3. In addition, the TSV1 bus is still processing command signal CMD3. However, the command signal bus has been released from processing command signal CMD3, and the TSV0 bus has been released from processing command signal CMD2. In addition, because there are no command signals to process on channel 0, both the TSV0 and TSV1 select signals of path select circuit 402 are low.

At time T6, the command decoder circuit for DEC0 of SID1 has completed processing the command signal CMD2. However, the command decoder circuit for DEC1 of SID1 is still processing the command signal CMD3. At time T7, the command decoder circuit for DEC1 of SID1 has completed processing the command signal CMD3.

As seen in FIG. 5, because there is more than one TSV bus per channel, the command signals can be processed by the TSV bus circuits and the command decoder circuits in staggered overlapping patterns. Accordingly, in exemplary embodiments of the present disclosure, the bandwidth can be increased while keeping the command signal bus saturated during operation of the HBM device.

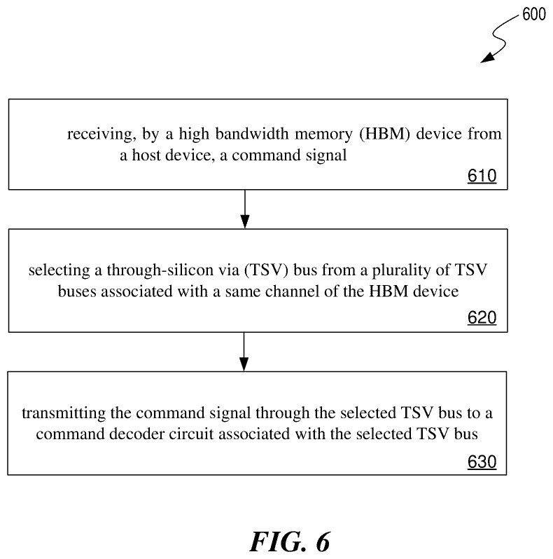

FIG. 6 illustrates a flow chart of a method 600 showing the method steps performed by one or more processors and/or hardwired circuitry in the SiP device such as, for example, the host device. In step 610, a HBM device receives from a host device, over a command interface associated with a channel, a command signal. For example, as discussed above and as seen in FIG. 5, the host device can transmit a command signal (e.g., CMD0) to the HBM device.

In step 620, the HBM device selects a TSV bus from a plurality of TSV buses associated with a same channel of the HBM device (e.g., the channel associated with the command interface over which the command signal was received). For example, as seen in FIGS. 3B and 4A, the HBM device 330 can include two TSV buses (e.g., TSV0 and TSV1) per channel (e.g., CH0) and a path select circuit 402 that can select between the TSV0 bus and the TSV1 bus based on a selection pattern. In some embodiments, the TSV of the multiple TSVs are selected in an alternating or round-robin fashion. For example, if TSV0 was selected for a first command associated with a channel, then TSV1 may be selected for a next command (e.g., a second command) associated with the same channel. It will be appreciated that this alternating pattern may be extended for embodiments with a greater number of command TSV buses per channel.

In step 630, the HBM device transmits the command signal through the selected TSV bus to a command decoder circuit associated with the selected TSV bus. For example, as seen in FIGS. 3B and 5, the HBM device 330 transmits command signal CMD0 to die DIE0 in SID0 via the selected TSV0 bus. Similarly, the HBM device 330 transmits command signal CMD1 to die DIE1 in SID0 via the selected TSV1 bus.

From the foregoing, it will be appreciated that embodiment of the present disclosure provide increased bandwidth over related art HBM devices while ensuring that the DRAM memory array timings, the TSV bus timings, and the DQ bus timings are all synchronized. For example, it will be appreciated that, in some embodiment, the data rate at the DQ pins are increased while still keeping the same memory array as related art HBM devices. In addition, by relaxing the frequency cycle timings in the TSV bus, embodiments of the present disclosure can perform low voltage switching in the TSV to keep the power consumption low. Further, embodiments of the present disclosure increase the number of bank groups that can be opened during a t_{CCDL} CLK cycle period in comparison to a related art HBM device, while still maintaining a 4N architecture and the same number of banks.

In addition, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where the context permits, singular or plural terms may also include the plural or singular term, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Further, the terms “generally”, “approximately,” and “about” are used herein to mean within at least within 10 percent of a given value or limit. Purely by way of example, an approximate ratio means within ten percent of the given ratio.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Thus, computer-readable media can comprise computer-readable storage media (e.g., “non-transitory” media) and computer-readable transmission media.

It will also be appreciated that various modifications may be made without deviating from the disclosure or the technology. For example, the dies in the HBM device can be arranged in any other suitable order (e.g., with the non-volatile memory die(s) positioned between the interface die and the volatile memory dies; with the volatile memory dies on the bottom of the die stack; and the like). Further, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. For example, although discussed herein as using a non-volatile memory die (e.g., a NAND die and/or NOR die) to expand the memory of the HBM device, it will be understood that alternative memory extension dies can be used (e.g., larger-capacity DRAM dies and/or any other suitable memory component). While such embodiments may forgo certain benefits (e.g., non-volatile storage), such embodiments may nevertheless provide additional benefits (e.g., reducing the traffic through the bottleneck, allowing many complex computation operations to be executed relatively quickly, etc.).

Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

We claim:

1. A system-in-package (SiP) device, comprising:
a base substrate;
a processing unit carried by the base substrate; and
a high bandwidth memory (HBM) device carried by the base substrate and electrically coupled to the processing unit,
wherein the HBM device comprises:
a plurality of through-silicon via (TSV) buses associated with a same channel;
an interface die, the interface die including a bus switching circuit configured to select a TSV bus from the plurality of TSV buses, each TSV bus having a set of TSVs, and to communicatively couple a command signal bus, communicatively coupled to the processing unit, to the selected TSV bus; and
one or more stacks carried by the interface die, each stack having one or more dies, wherein each die includes a plurality of command decoder circuits associated with the same channel, each command decoder circuit configured to decode command signals,
wherein each command decoder circuit in each die is associated with a different TSV bus in the plurality of TSV buses.

2. The SiP device of claim 1, wherein the bus switching circuit is configured such that a same TSV bus for the channel is not selected on consecutive command signals.

3. The SiP device of claim 1, wherein the plurality of TSV buses includes a first TSV bus and a second TSV bus.

4. The SiP device of claim 3, wherein the bus switching circuit selects the first TSV bus on a first command signal and selects the second TSV bus on a second command signal to the same channel, the first and second command signals being successive command signals.

5. The SiP device of claim 1, wherein the bus switching circuit selects between a first TSV bus and a second TSV bus based on a predetermined TSV selection pattern.

6. The SiP device of claim 1, wherein a data rate of the SiP device is greater than 8 gigabits per second (Gbps).

7. The SiP device of claim 1, wherein two or more command decoder circuits of the plurality of decoder circuits decode respective command signals in a staggered overlapping pattern.

8. A high bandwidth memory (HBM) device, comprising:
a plurality of through-silicon via (TSV) buses associated with a same channel;
an interface die, the interface die including a bus switching circuit configured to select a TSV bus from the plurality of TSV buses, each TSV bus having a set of TSVs, and to communicatively couple a command signal bus to the selected TSV bus; and
one or more stacks carried by the interface die, each stack having one or more dies, wherein each die includes a plurality of command decoder circuits associated with the same channel, each command decoder circuit configured to decode command signals,
wherein each command decoder circuit in each die is associated with a different TSV bus in the plurality of TSV buses.

9. The HBM device of claim 8, wherein the bus switching circuit is configured such that a same TSV bus for the channel is not selected on consecutive command signals.

10. The HBM device of claim 8, wherein the plurality of TSV buses includes a first TSV bus and a second TSV bus.

11. The HBM device of claim 10, wherein the bus switching circuit selects the first TSV bus on a first command signal and selects the second TSV bus on a second command signal to the same channel, the first and second command signals being successive command signals.

12. The HBM device of claim 8, wherein the bus switching circuit selects between a first TSV bus and a second TSV bus based on a predetermined TSV selection pattern.

13. The HBM device of claim 8, wherein a data rate of the HBM device is greater than 8 gigabits per second (Gbps).

14. The HBM device of claim 8, wherein two or more command decoder circuits of the plurality of decoder circuits decode respective command signals in a staggered overlapping pattern.

15. A method, comprising:
receiving, by a high bandwidth memory (HBM) device from a host device, a command signal;
selecting a through-silicon via (TSV) bus from a plurality of TSV buses associated with a same channel of the HBM device; and
transmitting the command signal to a die in the HBM device through the selected TSV bus to a command decoder circuit associated with the selected TSV bus.

16. The method of claim 15, wherein each TSV bus of the plurality of TSV buses associated with the same channel is associated with a different command decoder circuit.

17. The method of claim 15, wherein the plurality of TSV buses includes a first TSV bus and a second TSV bus.

18. The method of claim 17, wherein the selecting comprises selecting the first TSV bus on a first command signal and selecting the second TSV bus on a second command signal to the same channel, the first and second command signals being successive command signals.

19. The method of claim 18, wherein decoding of the first and second command signals is performed in a staggered overlapping pattern.

20. The method of claim 15, wherein the selecting comprises selecting between a first TSV bus and a second TSV bus based on a predetermined TSV selection pattern.
